(19) United States
(12) Patent Application Publication
(10) Pub. No.: US 2010/0006483 A1
(43) Pub. Date: Jan. 14, 2010

(54) Replaceable filter elements including unique pressure relief and systems including same

(76) Inventors: Ravi Yekula, Charlottesville, VA (US); John Clevenger, Antioch, TN (US); Harold Martin, Cookeville, TN (US); Abby True-Dahl, Sparta, TN (US); Carey Curt, Cookeville, TN (US); Benjamin Ott, Nashville, TN (US); Brian J. Terry, Hilham, TN (US)

Correspondence Address: HAMRE, SCHUMANN, MUELLER & LARSON, P.C., P.O. BOX 2902, MINNEAPOLIS, MN, 55402-0902, US

(21) Appl. No.: 12/218,025

(22) Filed: Jul. 10, 2008

(51) Int. Cl. B01D 27/06; F02M 37/22; B01D 35/143

(52) U.S. Cl. 210/85; 210/437; 210/457; 210/440

(57) ABSTRACT

According to one embodiment a replaceable filter element includes a substantially annular filter media extending from a first end to a second end and has an exterior, a substantially hollow interior, and a first permeability. A first end plate is coupled to the first end of the substantially annular filter media. The first end plate includes an aperture leading to the substantially hollow interior of the substantially annular filter media. The replaceable filter element includes a filter media piece positioned adjacent the second end of the substantially annular filter media and has a second permeability less than the first permeability. The replaceable filter element includes an outer wrap extending from the second end of the substantially annular filter media along a portion of the exterior of the substantially annular filter media. Further embodiments, forms, objects, features, advantages, aspects, and benefits shall become apparent from the following description and drawings.

### BACKGROUND

Replaceable filter elements can be used in filtration systems for a variety of applications including, for example, in connection with fuels, lubricants, coolants, hydraulic and other liquids of internal combustion engines such as diesel engines. Replaceable filter elements can be used in filtration systems to remove particulates and other undesirable matter from fluids. Present approaches to such elements and systems suffer from a variety of disadvantages, drawbacks, limitations and problems including those respecting pressure regulation and relief, component interconnection, complexity, part count, and others. There is a need for the unique and inventive replaceable filter elements and systems disclosed herein.

### SUMMARY

According to one embodiment a replaceable filter element includes a substantially annular filter media extending from a first end to a second end and has an exterior, a substantially hollow interior, and a first permeability. A first end plate is coupled to the first end of the substantially annular filter media. The first end plate includes an aperture leading to the substantially hollow interior of the substantially annular filter media. The replaceable filter element includes a filter media piece positioned adjacent the second end of the substantially annular filter media and has a second permeability less than the first permeability. The replaceable filter element includes an outer wrap extending from the second end of the substantially annular filter media along a portion of the exterior of the substantially annular filter media. Further embodiments, forms, objects, features, advantages, aspects, and benefits shall become apparent from the following description and drawings.

### BRIEF DESCRIPTION OF THE FIGURES

FIG. 1 is a side view of a vehicle including an engine and a fuel filtration system.

FIG. 2 is a perspective view of a replaceable filter element.

FIG. 2A is a sectional view of FIG. 2.

FIG. 3 is a perspective view of a replaceable filter element.

FIG. 3A is a sectional view of FIG. 3.

FIG. 4 is a perspective view of a replaceable filter element.

FIG. 4A is a sectional view of FIG. 4.

FIG. 5 is a side view of a filtration system including a replaceable filter element.

### DETAILED DESCRIPTION

For purposes of promoting an understanding of the principles of the invention, reference will now be made to the embodiments illustrated in the figures and specific language will be used to describe the same. It will nevertheless be understood that no limitation of the scope of the invention is thereby created, and that the invention includes and protects such alterations and modifications to the illustrated embodiments, and such further applications of the principles of the invention illustrated therein as would occur to one skilled in the art to which the invention relates.

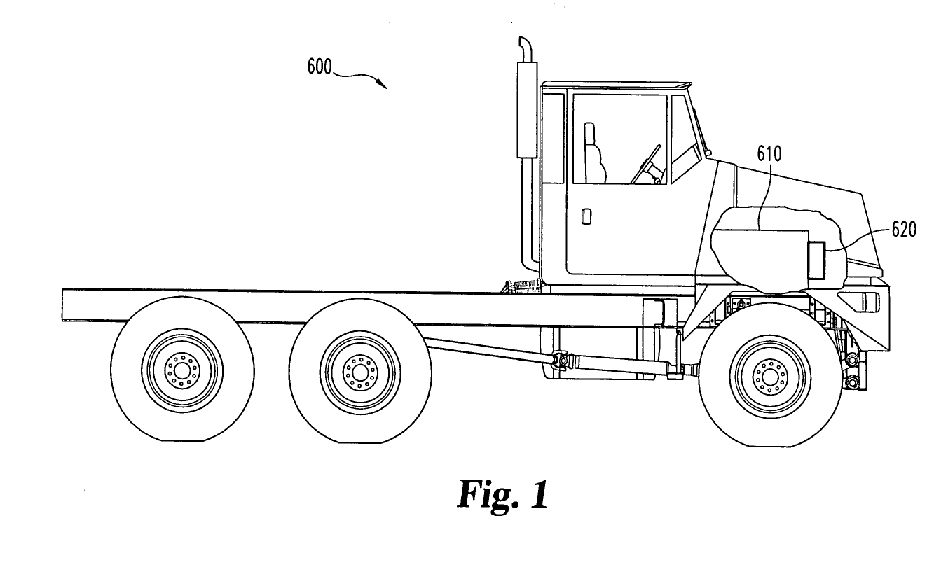

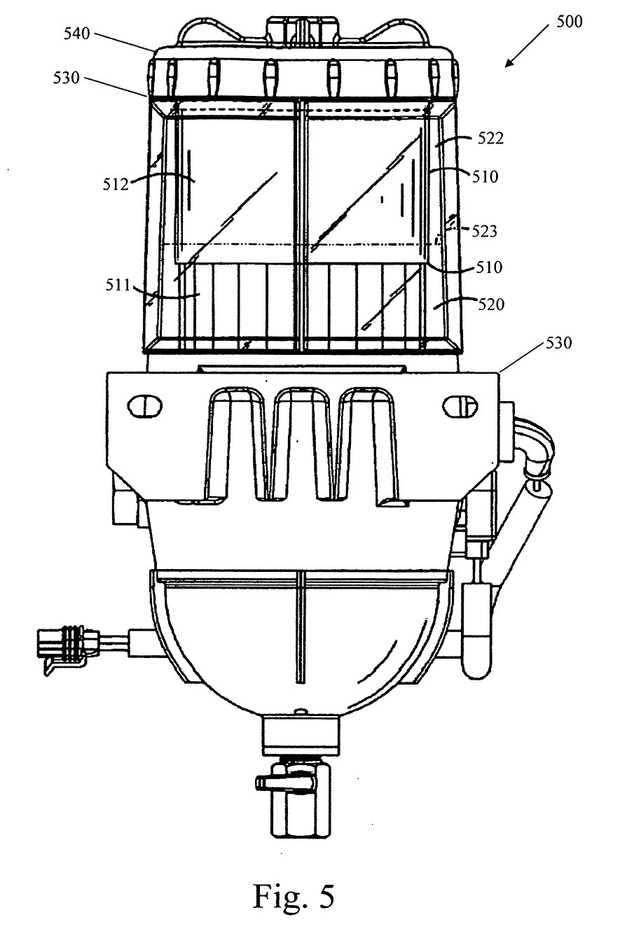

With reference to FIG. 1 there is illustrated a vehicle 600. Vehicle 600 is shown as a semi tractor, but could also be a variety of types of vehicles, for example, light duty trucks, medium duty trucks, heavy duty trucks, buses, cars, motorhomes, fire and emergency vehicles, construction, vehicles, boats and other marine vehicles, and rail vehicles such as locomotives. Vehicle 600 includes an engine 610, which is preferably a diesel engine but could be a spark ignition or other type of internal combustion engine, and a fuel filtration system 620 which is operable to filter fuel to be provided to engine 610. Fuel filtration system 620 could be the same as or similar to fuel filtration system 500 described below in connection with FIG. 5 or could be another type of fuel filtration system. Further embodiments contemplate that engine 610 could be used in other applications including, for example, in generator sets, or industrial, mining, or oil and gas equipment.

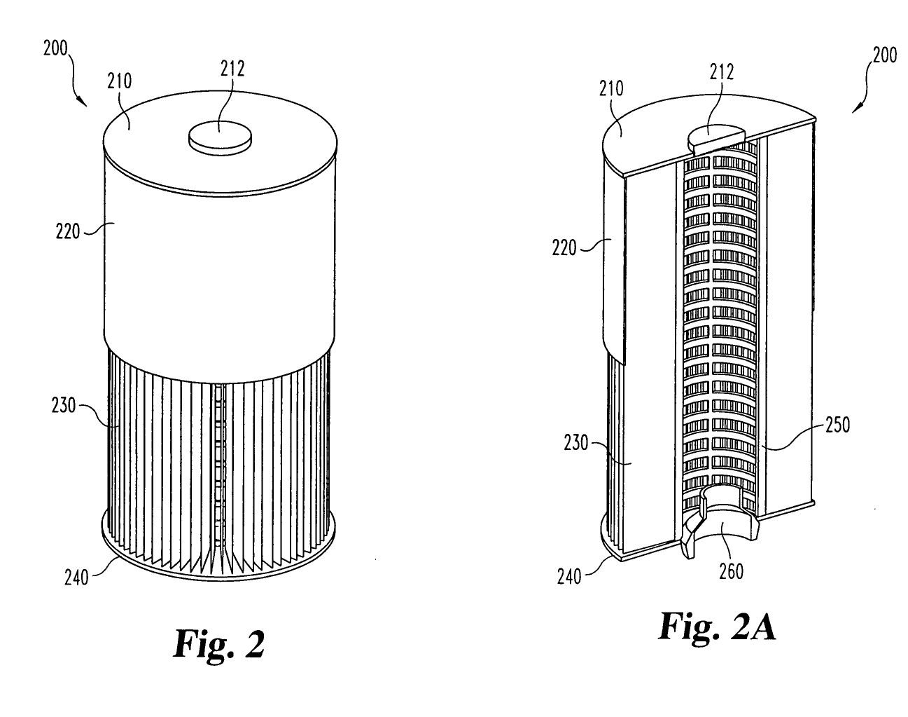

With reference to FIGS. 2 and 2A, there is illustrated an exemplary replaceable filter element 200. Replaceable filter element 200 includes filter media 230 which is in an annular pleated configuration, plastic end plate 210 which is coupled to one end of filter media 230, preferably by a portion of filter media 230 being embedded in plastic end plate 210, plastic end plate 240 which is coupled to another end of filter media 230, preferably by a portion of filter media 230 being embedded in plastic end plate 240, and plastic outer wrap 220 which is coupled to plastic end plate 210 and extends from about one end of filter media 230 along a portion of its exterior, and in which a portion of filter media 230 is preferably embedded.

Replaceable filter element 200 further includes a filter media piece 212 which is preferably embedded in plastic end plate 210. While filter media piece 212 is illustrated as having a substantially circular or disc shape, it should be appreciated that filter media pieces having a variety other shapes, for example, ellipsoid, oval, square, rectangular or other polygon shapes could be used.

Replaceable filter element 200 also includes plastic center tube 250 which is positioned in the substantially hollow interior of filter media 230, and may extend over part or all of the distance intermediate plastic end plate 210 and plastic end plate 240, and may contact or be coupled with plastic end plate 210 and/or plastic end plate 240. A gasket 260 can be inserted into an opening formed in plastic end plate 240 to provide sealing between replaceable filter element and other components of a filtration system. Other embodiments may omit a plastic center tube or may have a plastic center tube which differs from plastic center tube 250.

Embedding of the various elements referred to herein is preferably accomplished by sonic welding. Embedding could also be accomplished by other techniques and processes, for example, use of a potting material such as plastisol or other adhesives or glues, by forming or molding one element around a portion of another, by flame embedding, by laser welding, by heat welding, or by combinations of these and other techniques and processes.

Replaceable filter element 200 is preferably of the type appropriate for filtration of diesel fuel, but can also be of the types appropriate for filtration of other fuels, or other engine fluids such as lubricants, coolants, hydraulic fluids, as well as other types of fluids. During operation fuel is introduced into the substantially hollow interior of filter media 230. Filtration occurs as fuel passes through filter media 230 while contaminants such as particulates and other matter are trapped by filter media 230.

During operation, fuel may rise within the substantially hollow interior of filter media 230 from plastic end plate 240 to about the level of the bottom of plastic outer wrap 220. As fuel rises over this range gasses occupying the portion of the substantially hollow interior of filter media 230 may escape through filter media 230 to accommodate the increasing fuel volume. Once the fuel level rises above level of the bottom of plastic outer wrap 220, gasses may no longer escape or may escape only with greater difficulty or at a lesser rate. As the fuel level continues to rise, gasses within the substantially hollow interior of filter media 230 are compressed and a head of pressure is created.

A certain magnitude of pressure can contribute to filtration. Pressure of too great a magnitude, however, may lead to undesirable consequences, such as the inability of a fueling system to continue to provide fuel to replaceable fuel filter 200 or failure of replaceable fuel filter 200. Filter media piece 212 provides a means for releasing pressure. After pressure is released, the fuel level may transition to a lower level. Multiple fuel level rises, pressure releases and falls may occur over the useful life of the filter element.

Filter media piece 212 is in flow communication with the substantially hollow interior of filter media 230. Filter media piece 212 has a lesser permeability than filter media 230. As used herein, permeability refers to the capacity of a given filter media article to pass fluid. The permeability of a filter media article may be greater or less than the permeability of another filter media article due to the two filter media articles including different materials, having different thicknesses, different porosities, different numbers of layers, different internal structures or voids, different dimensions, and/or differences in other properties or characteristics. The lesser permeability of filter media piece 212 allows a head of pressure to be created within the substantially hollow interior of filter media 230 while avoiding overpressuriziation. The desired degree or range of pressure may vary between embodiments and the characteristics of filter media piece may be selected to provide different predetermined pressure magnitudes as may be appropriate from embodiment to embodiment.

It should be appreciated that additional embodiments contemplate variations on the illustrated embodiment of replaceable fuel filter 200. In further embodiments, filter media 230 could be in a variety of alternate configurations which also provide means for filtering fuel or other liquid(s), for example, filter media, having a variety of different cross sectional shapes such as oval, rectangular or others, a z-type configuration, flutes and still other filter media arrangements.

In additional embodiments, endplate 210, endplate 240, outer wrap 220, and/or center tube 250 could include or be formed from additional or alternate materials, for example, composites, metals or other materials. In other embodiments, endplate 210, endplate 240, outer wrap 220, and/or center tube 250 could have a variety of different shapes and dimensions or might be absent or provided separately from replaceable filter element 200.

Additional embodiments may include other means for coupling with filter media 230 and/or media disc 212 in addition to or instead of endplates 210 and 240 and/or outer wrap 220, for example, one or more couplings other than embedding. Further embodiments may include other means for creating a pressure head instead of or in addition to outer wrap 220, for example, outer members having different dimensions, or formed of different materials.

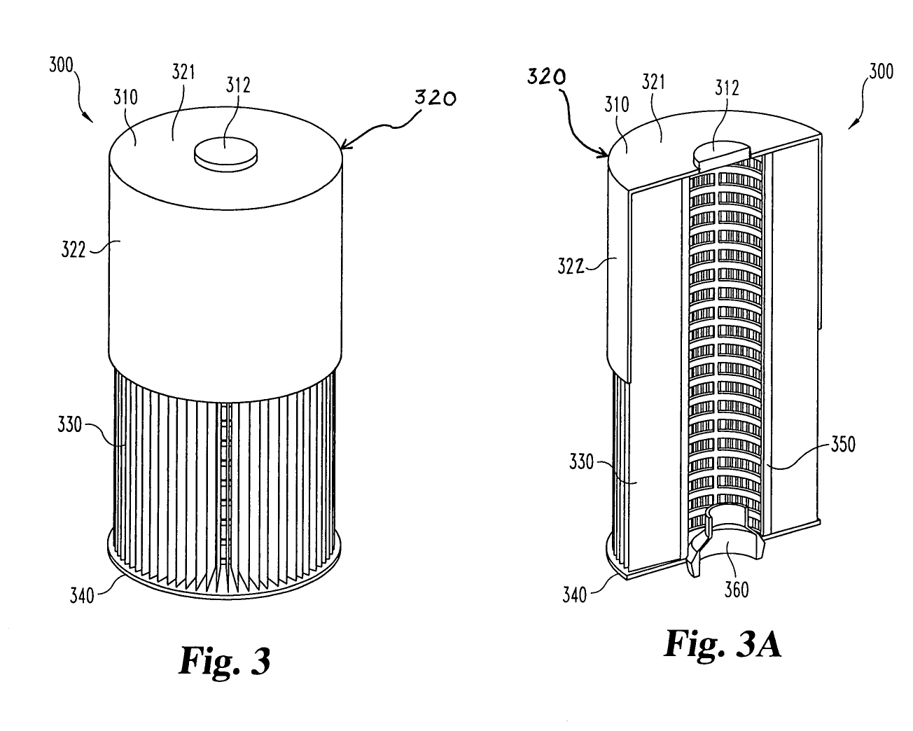

With reference to FIGS. 3 and 3A, there is illustrated another exemplary replaceable filter element 300. Replaceable filter element 300 includes filter media 330 which is in an annular pleated configuration, plastic member 320 which includes an end plate portion 321 which is coupled to one end of filter media 330, preferably by a portion of filter media 330 being embedded in plastic end plate 310, and plastic outer wrap portion 322 which extends from one end of filter media 330 along a portion of its exterior, and in which a portion of filter media 330 is preferably embedded.

Replaceable filter element 300 also includes plastic end plate 340 which is coupled to another end of filter media 330, preferably by an end of filter media 330 being embedded in plastic end plate 340. Replaceable filter element 300 further includes a filter media piece 312 preferably embedded in plastic end plate portion 321.

Replaceable filter element 300 also includes plastic center tube 350 which is positioned in the substantially hollow interior of filter media 330, extends intermediate plastic end plate portion 321 and plastic end plate 340, and may contact or be coupled to plastic end plate portion 321 and plastic end plate 340. A gasket 360 can be inserted into an opening formed in plastic end plate 340 to provide sealing between replaceable filter element 300 and other components of a filtering system. Other embodiments may omit a plastic center tube or may have a plastic center tube which differs from plastic center tube 350.

Replaceable filter element 300 is preferably of the type appropriate for diesel fuel filtration, but can be used for various additional and alternative applications as described above in connection with replaceable fuel filter element 200. Additionally, the operation of replaceable filter element 300 can be the same as or similar to that of replaceable filter element 200. Furthermore, the additional embodiments, alternatives, variations, modifications, materials, means and/or options described above in connection with replaceable fuel filter element 200 are also applicable to replaceable fuel filter element 300.

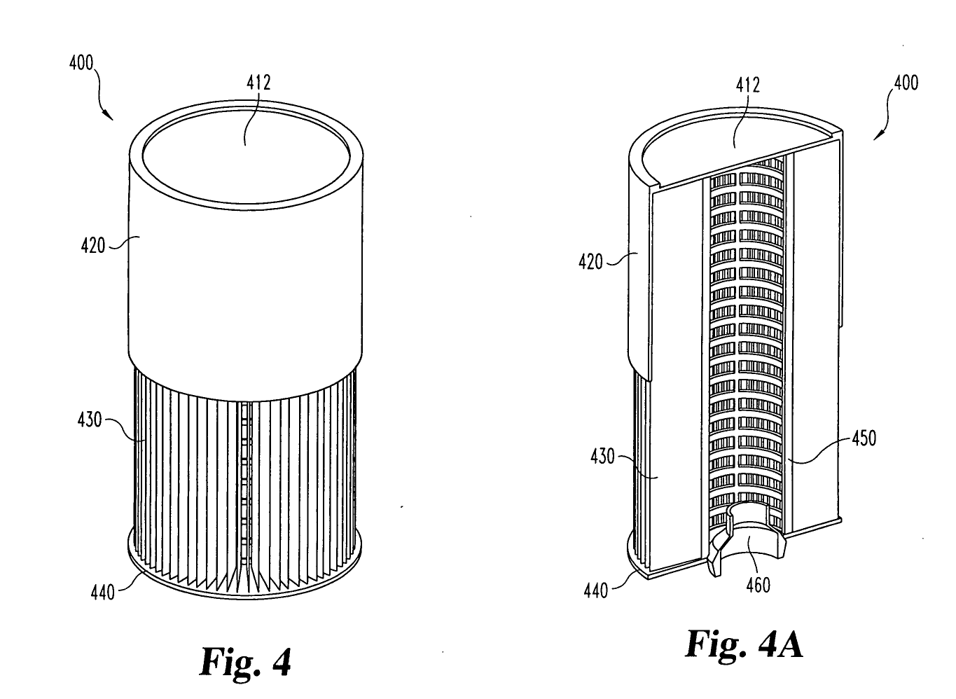

With reference to FIGS. 4 and 4A, there is illustrated a replaceable filter element 400. Replaceable filter element 400 includes filter media 430 which is in an annular pleated configuration, plastic end plate 440 which is coupled to an end of filter media 430, preferably by an end of filter media 430 being embedded in plastic end plate 440, and plastic outer wrap 420 which is coupled to plastic end plate 410 and extends from one end of filter media 430 along a portion of its exterior, and in which a portion of filter media 430 is preferably embedded. Replaceable filter element 400 further includes a filter media piece 412 which is preferably embedded in a flange of plastic outer wrap 420 that extends radially inward along the end of filter media 430. Replaceable filter element 400 also includes plastic center tube 450 which is positioned in the substantially hollow interior of filter media 430, extends intermediate filter media piece 412 and plastic end plate 440, and may contact or be coupled to filter media piece 412 and plastic end plate 440. A gasket 460 can be inserted into an opening formed in plastic end plate 440 to provide sealing between replaceable filter element 400 and other components of a fuel filtering system. Other embodiments may omit a plastic center tube or may have a plastic center tube which differs from plastic center tube 450.

Replaceable filter element 400 is preferable of the type appropriate for diesel fuel filtration, but can be used for the various additional and alternative applications as described above in connection with replaceable fuel filter element 200. Additionally, the operation of replaceable filter element 400 can be the same as or similar to that of replaceable filter element 200. Furthermore, the additional embodiments, alternatives, variations, modifications, materials, means and/or options described above in connection with replaceable fuel filter element 200 are also applicable to replaceable fuel filter element 400.

With reference to FIG. 5 there is illustrated a fuel filtration system 500. Fuel filtration system 500 includes replaceable fuel filter element 510, a head 530, a housing 529, and a lid 540. Replaceable fuel filter element 510 includes filter media 511 and outer wrap 512. Replaceable fuel filter element 510 is received within a housing 529 and extends intermediate head 530 and lid 540. Replaceable fuel filter element 510 could be the same as or similar to replaceable fuel filter elements 200, 300, or 400 described above. Lid 540 can include a vent. A spring can be positioned intermediate replaceable fuel filter element 510 and shell lid 540 to bias replaceable fuel filter element 510 toward filter head 520 when fuel filtration system 500 is assembled. Filter head 520 includes a nozzle which coupled with filter head 520 and directs fuel into a substantially hollow interior portion of replaceable fuel filter element 510. Filter head 520 includes a fuel inlet, a fuel outlet and can also include a check valve, an access valve, a drain valve, a water in fuel sensor, a DC electric heater and/or an AC electric heater. Fuel level 523 is visible through housing 529 and could be higher or lower as indicated by reference numerals 520 and 522.

As is clear from figures and related text presented above, a variety of embodiments according to the present invention are contemplated. Certain exemplary embodiments comprise a replaceable filter element including a substantially annular filter media extending from a first end to a second end and having an exterior, a substantially hollow interior, and a first permeability; a first end plate coupled to the first end of the annular filter media, the first end plate including an aperture leading to the substantially hollow interior of the annular filter media; a media piece positioned adjacent the second end of the annular filter media, the filter media piece having a second permeability, the first permeability being greater than the second permeability; and an outer wrap extending along a portion of the exterior of the annular filter media. Further exemplary embodiments include a second end plate coupled to the second end of the annular filter media and coupled to the filter media piece; a center tube positioned in the substantially hollow interior of the annular filter media; the filter media piece having a greater thickness than the annular filter media; the filter media piece covering substantially the entire second end of the annular filter media; the filter media piece being coupled directly to the annular filter media; the filter media piece being embedded in a second end plate; or may further include a fuel filtration system including a receptacle which receives the replaceable filter element.

Additional exemplary embodiments comprise a replaceable filter element including means for filtering liquid having a first end, a second end, an exterior, a substantially hollow interior, and a first thickness; an end plate coupled with the first end having an opening providing access to the substantially hollow interior; means for releasing pressure positioned adjacent the second end, the means for releasing pressure having a second thickness being greater than the first thickness; and means for creating a pressure head during filtration extending along a portion of the exterior of the means for filtering liquid. In further exemplary embodiment the means for filtering liquid includes a pleated annular filter media; the means for releasing pressure includes a filter media disc; the means for creating a pressure head during filtration includes an outer wrap; the means for releasing pressure covers substantially all of an end of the pleated annular filter media; and/or the means for creating a pressure head includes a lip which overlaps the means for releasing pressure.

Additional exemplary embodiments comprise a replaceable filter element including a filter media extending from a first end to a second end and having an exterior and a substantially hollow interior, the filter media having a first permeability; a first end portion coupled to the first end of the filter media, the first end portion including an aperture leading to the substantially hollow interior of the filter media; a second end portion coupled to the second end of the filter media; an outer cover extending from the second end of the filter media along a portion of the exterior of the filter media; and a filter media piece positioned embedded in one of the second end portion and the outer cover, the filter media piece having a second permeability, the first permeability being different than the second permeability. In further exemplary embodiments at least a portion of the filter media is embedded in the outer cover; the outer cover and the second end portion are a unitary piece; the second end portion is a flange of the outer cover; the second end portion and the outer cover are discrete pieces that are bonded to one another.

Certain embodiments include replaceable filter elements which include indication means for changing a visible color based upon the pH of a fluid in contact with the indication means. Such embodiment may include, for example, those discussed above in connection with FIGS. 1-5 as well as others. In one example of such an embodiment a filter media piece, such as, for example, filter media piece 212, 312, or 412, includes a color indicator which changes color in response to a change in pH of fluid in contact with the color indicator. Such embodiments may involve, for example, by applying a indicative reagent to a filtration substrate. Certain specific examples include application of one or more compounds which express a change in a visible color based upon the pH of a fluid in contact with the compound. These and other embodiments may involve, for example, formation by co-forming one or more indicative reagents and a filtration substrate wherein one or more compounds which provide filtration are coformed with one or more compounds which provide means for indicating filter life which includes display of a visible color. Examples of coforming include mixing, spraying cospinning, coreaction, sintering, fluidic mixing, chemical vapor deposition, and/or physical deposition. Further examples include combinations of the foregoing and the other features, techniques and configurations disclosed, implied and evident herein.

Certain embodiments may include a fuel filtration system including a receptacle which receives the replaceable filter element; wherein the filter media piece provides limp home filtration once the filtration capacity of the filter media is substantially depleted. Such embodiment may include, for example, those discussed above in connection with FIGS. 1-5 as well as others.

While exemplary embodiments of the invention have been illustrated and described in detail in the figures and foregoing description, the same is to be considered as illustrative and not restrictive in character, it being understood that only the preferred embodiments have been shown and described and that all changes and modifications that come within the spirit of the invention are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, so the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a replaceable filter element including
a substantially annular filter media extending from a first end to a second end and having an exterior, a substantially hollow interior, and a first permeability;
a first end plate coupled to the first end of the annular filter media, the first end plate including an aperture leading to the substantially hollow interior of the substantially annular filter media;
a filter media piece positioned adjacent the second end of the substantially annular filter media, the filter media piece having a second permeability, the first permeability being different than the second permeability; and
an outer wrap extending along a portion of the exterior of the substantially annular filter media.

2. An apparatus according to claim 1 further comprising a second end plate coupled to the second end of the substantially annular filter media and coupled to the filter media piece.

3. An apparatus according to claim 1 further comprising a center tube positioned in the substantially hollow interior of the substantially annular filter media.

4. An apparatus according to claim 1 wherein the filter media piece has a greater thickness than the substantially annular filter media.

5. An apparatus according to claim 1 wherein the filter media piece covers substantially the entire second end of the substantially annular filter media.

6. An apparatus according to claim 1 wherein the filter media piece is coupled directly to the substantially annular filter media.

7. An apparatus according to claim 1 wherein the filter media piece is embedded in a second end plate.

8. An apparatus according to claim 1 further comprising a fuel filtration system including a receptacle which receives the replaceable filter element.

9. An apparatus according to claim 1 wherein the filter media piece and the outer wrap are sonically welded to one another.

10. An apparatus according to claim 1 wherein the outer wrap and the filter media piece are coupled to one another with a potting compound.

11. A replaceable filter element comprising:
means for filtering liquid having a first end, a second end, an exterior, a substantially hollow interior, and a first thickness;
an end plate coupled with the first end having an opening providing access to the substantially hollow interior;
means for releasing pressure positioned adjacent the second end, the means for releasing pressure having a second thickness being greater than the first thickness; and
means for creating a pressure head during filtration extending along a portion of the exterior of the means for filtering liquid.

12. A replaceable filter element according to claim 11 wherein the means for filtering liquid includes a pleated annular filter media.

13. A replaceable filter element according to claim 11 wherein the means for releasing pressure includes a filter media disc.

14. A replaceable filter element according to claim 11 wherein the means for creating a pressure head during filtration includes an outer wrap.

15. A replaceable filter element according to claim 12 wherein the means for releasing pressure covers substantially all of an end of the pleated annular filter media.

16. A replaceable filter element according to claim 15 wherein the means for creating a pressure head includes a lip which overlaps the means for releasing pressure.

17. A replaceable filter element according to claim 11 further comprising indication means for changing a visible color based upon the pH of a fluid in contact with the indication means.

18. An apparatus comprising:
a replaceable filter element including
a filter media extending from a first end to a second end and having an exterior and a substantially hollow interior, the filter media having a first permeability;
a first end portion coupled to the first end of the filter media, the first end portion including an aperture leading to the substantially hollow interior of the filter media;
a second end portion coupled to the second end of the filter media;
an outer cover portion extending from about the second end of the filter media along a portion of the exterior of the filter media; and
a filter media piece embedded in the second end portion, the filter media piece having a second permeability, the first permeability being different than the second permeability.

19. An apparatus according to claim 18 wherein at least a portion of the filter media is embedded in the outer cover portion.

20. An apparatus according to claim 18 wherein the outer cover portion and the second end portion are a unitary piece.

21. An apparatus according to claim 18 wherein the second end portion is a flange of the outer cover portion.

22. An apparatus according to claim 18 wherein the second end portion and the outer cover portion are discrete pieces that are bonded together.

23. An apparatus according to claim 18 further comprising a fuel filtration system, the replaceable filter element being disposed within a receptacle of the fuel filtration system.

24. An apparatus according to claim 18 wherein the filter media piece includes a color indicator which changes color in response to a change in pH of a fluid in contact with the color indicator.

25. An apparatus according to claim 18 further comprising a fuel filtration system including a receptacle which receives the replaceable filter element; wherein the filter media piece provides limp home filtration once the filtration capacity of the filter media is substantially depleted.
